(19) United States
(12) Patent Application Publication
(10) Pub. No.: US 2024/0225014 A1
(43) Pub. Date: Jul. 11, 2024

(54) Roller with Replaceable Shell

(71) Applicant: General Mills, Inc., Minneapolis, MN (US)

(72) Inventors: Gary O. Bendickson, Clear Lake, MN (US); Molly Moen, Rosemount, MN (US); Olivia Murch, Minneapolis, MN (US); Emily A. Ryks, Maple Grove, MN (US); Ralph A. Stenvik, Plymouth, MN (US); Keegan Withey, Hopkins, MN (US)

(21) Appl. No.: 18/093,451

(22) Filed: Jan. 5, 2023

(51) Int. Cl. A21C 11/08

(52) U.S. Cl. CPC A21C 11/08

(57) ABSTRACT

A roller is provided with replaceable shells formed of panels. The roller includes a shaft extending in a longitudinal direction. A center flange and two end flanges are mounted on the shaft and extend radially outward from the shaft at axially spaced locations. Between each end flange and one side of the center flange, a replaceable shell is provided. Preferably, multiple additional center flanges and replaceable shells are mounted on the shaft between the end flanges. An internal pin system is employed to ensure no screws are visible while holding the shell panels in place.

### BACKGROUND OF THE INVENTION

The invention pertains to the art of rollers used in industries, such as the food production industry and, more particularly, to producing edible dough products with rollers.

Food manufacturers often make large quantities of dough-based products. To do so, the manufactures often employ machinery that moves dough from a hopper or other source of dough through processing rollers to form dough products which are then placed onto a conveyer and sent into an oven for baking. However, many different types of rollers are employed during the manufacture of food. In each case the roller has an outer surface with a specific structure designed for a particular role. For example, mold rollers have die cavities for molding dough products, feed rollers have patterns for pushing dough, and cutting rollers have blades for cutting dough products.

In some arrangements, a combination of a feed roller with ridges and a mold roller with die cavities work together to process dough. The shape of the die cavities determines the shape of the final dough products. Some mold rollers are used in producing round cookies, while other mold rollers produce polygonal-shaped cookies or other baked dough products. A problem occurs when the surface of a roller wears out or when a different dough product is desired such that the roller must be replaced. The feed rollers are very heavy solid units which makes them difficult to remove. Rollers designed for certain types of dough, such as soft dough matrices, will not work well with different dough types. For example, a heavy solid feed roller for soft dough types crushes higher particulate/drier doughs. This creates waste and sometimes results in chunks of crushed particles in the final food product, which is considered undesirable. In any case, replacing a roller is a complicated and expensive process. The rollers are not only heavy but also often difficult to access or remove from an operating position. Therefore, there exists a need in the art for a roller that is easily adapted to different roles and can overcome the problems outlined above.

### SUMMARY OF THE INVENTION

The invention is directed to providing a roller with replaceable shells formed of panels, with each panel having a surface of a desired shape and texture. The roller includes a shaft extending in a longitudinal direction. A center flange is mounted on the shaft and extends radially outward from the shaft. Likewise, two end flanges also are mounted on the shaft and extend radially outward from the shaft. Between each end flange and the center flange there is located a replaceable shell. Preferably, multiple additional center flanges and replaceable shells are mounted on the shaft between the end flanges. An internal pin system secures the replaceable shells in place and ensures no screws are visible on an outer surface of the panels. The panel designs are configured to achieve many goals, including to reduce pressure on the dough.

The connection between an end flange and the shaft allows for quick mounting of the replaceable shells to the shaft. The shaft has a central section which supports the central flanges and replaceable shells. The shaft includes axially facing walls, one at each end of the shaft, formed with threaded mounting holes. Each end flange includes inner mounting holes, which are preferably threaded, and outer mounting holes, which are sized to receive pins and are located radially outward of the inner mounting holes. Preferably, the end flange is formed of multiple components combined to form the shape of a washer. The multiple components fit around the shaft and are preferably in a clamshell arrangement. Threaded fasteners are placed through the inner mounting holes of the end flange into the threaded mounting holes in the shaft to secure the end flange in place. Pin connectors are mounted in the outer mounting holes of the end flange and extend into mounting holes in the replaceable shell to hold the replaceable shell in place. The pins are preferably sized to protrude from the flange when placed in the outer mounting holes. Alternatively, the pins may be fixed to the end flange so as to protrude from the end flange and into the mounting holes on the shell.

As noted above, the roller may have central flanges in addition to the end flanges. An additional central flange allows for two axially spaced replaceable shells, with the central flange located therebetween. Pins extend from both sides of the central flanges so as to engage the replaceable shells. The pins are press-fit into the mounting holes or otherwise attached to the central flanges. In a similar manner, a second central flange allows for three replaceable shells. As many central flanges as desired may be added. Both the central flanges and the replaceable shells are preferably formed of multiple components that fit around the shaft. Seals can be optionally added between the replaceable shells, if desired, to prevent contamination.

The roller includes replaceable shells preferably adapted for a particular use. For example, the roller may be a mold roller with a replaceable shell having mold cavities, or a feed roller with a replaceable shell with ridges. This way, one roller is adaptable to many different uses. Also, new panels may be produced, such as by three-dimensional printing with plastic material. Therefore, different surface patterns can be readily created on the replaceable shells. The different surface patterns can be quickly employed because the replaceable shells are easily switched with different replaceable shells.

The invention is also directed to a method of replacing shells of a roller in order to remove a damaged or worn shell or to add a shell with a differently designed outer surface configured to perform a different function. The method allows for mounting the replaceable shells on the central shaft which extends in a longitudinal direction. To start, an end flange, formed with inner and outer mounting holes, is placed on the shaft, with the shaft having an axially facing wall with threaded mounting holes. The end flange has a central aperture which allows the end flange to be slid along the shaft until the end flange abuts the axially facing wall. Threaded fasteners are placed through the inner mounting holes and into the threaded holes to secure the end flange in place. The end flange is preferably formed of pieces that are fit around the shaft. The multiple pieces are fit around the shaft without having to remove the shaft from a working position.

A replaceable shell is slid along the shaft until the replaceable shell abuts the end flange. Alternatively, the shell is of a clamshell design and is wrapped around the shaft. The replaceable shell is fastened to the end flange by passing fasteners, such as pins, located in the outer mounting holes of the end flange into the mounting holes in the replaceable shell. An additional end flange may then be placed on the shaft and fastened thereto in a similar manner as the other end flange by passing fasteners, such as pins located in the outer mounting holes of the end flange into mounting holes in the replaceable shell and passing fasteners, such as threaded fasteners, through the inner mounting holes of the end flange into mounting holes in the shaft. If a longer roller is employed, more replaceable shells may be added by placing a center flange on the shaft and sliding the center flange along the shaft to abut with the replaceable shell and then fastening the center flange to the replaceable shell by passing fasteners located in the mounting holes of the center flange into mounting holes in the replaceable shell and then sliding a second end flange along the shaft to abut with the replaceable shell. Once again, the method includes fastening the second end flange to the replaceable shell.

The replaceable shells are removed by first removing an end flange. More specifically, the fasteners holding the end flange to the shaft are removed, allowing the end flange to be removed in pieces. The replaceable shell is slid to an easy access point and then removed. Similarly, the remaining sections of the roller can be slid along the shaft and removed in a corresponding manner.

Additional objects, features and advantages of the invention will become more readily apparent from the following detailed description of preferred embodiments thereof when taken in conjunction with the drawings wherein like reference numerals refer to common parts in the several views.

### BRIEF DESCRIPTION OF THE DRAWINGS

FIG. 1 shows a perspective view of a portion of a production line for producing dough pieces showing a set of rollers, including a feed roller and a mold roller of a molding machine, constructed in accordance with a preferred embodiment of the invention.

FIG. 2 shows an enlarged perspective view of a portion of the feed roller shown in FIG. 1.

FIG. 3 shows a perspective view of the feed roller of FIG. 2, with an end flange removed.

FIG. 4 is a perspective, partially cut-away view of the feed roller of FIG. 2 illustrating the fastening of panels to a central shaft.

FIG. 5 presents a perspective cut-away view of the feed roller of FIG. 2 showing a section of panels removed and half of a mounting flange removed.

FIG. 6 is a perspective cut-away view of the feed roller of FIG. 5 showing an additional section of panels removed and half of a mounting flange removed.

FIG. 7 shows a perspective view of a shaft with only one replaceable shell mounted thereon.

FIG. 8 shows a perspective view of the roller of FIG. 2 with the shaft removed.

### DETAILED DESCRIPTION OF EMBODIMENTS

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to employ the present invention.

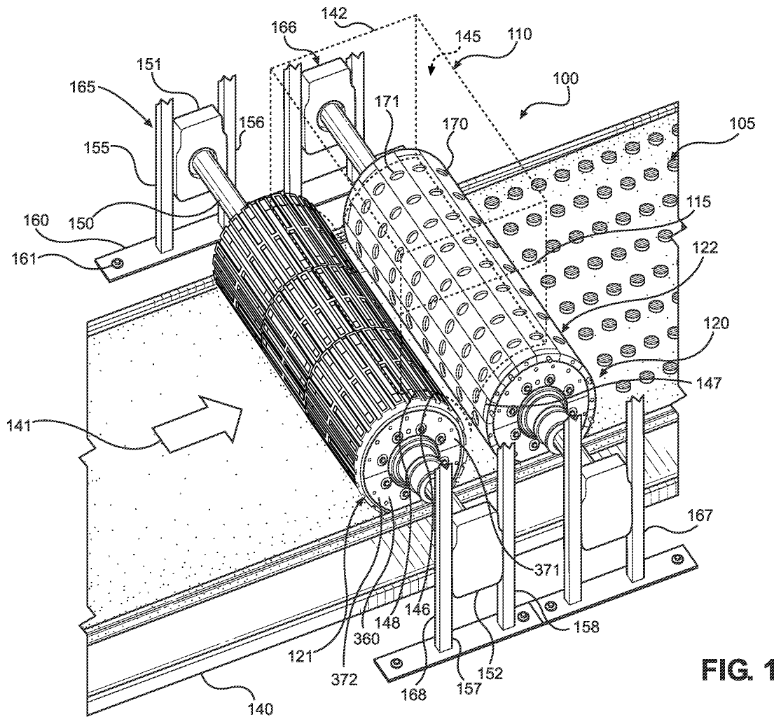

FIG. 1 shows a perspective view of a portion of a production line, including a molding machine 100 for producing dough pieces 105, showing a hopper 110 (in phantom) feeding dough 115 to a set of rollers 120. The set of rollers 120 include a feed roller 121 and a mold roller 122, with the set of rollers 120 mounted in the molding machine 100 so as to create and direct the dough pieces 105 along a conveyor 140 in the direction of arrow 141 to an oven, not shown.

The hopper 110 is seen mounted at the top of the molding machine 100 in a conventional manner. The hopper 110 is shown in a hidden view to show the set of rollers 120, more clearly. The hopper 110 is configured to receive dough at an upper portion 142 and to temporarily store the dough 115 until the dough 115 is needed. The hopper 110 has a main storage area 145 centrally located in the hopper 110 and a dispenser 146 located at the bottom portion of the hopper 110. The dispenser 146 is formed of two converging walls 147, 148 and a scraper (not shown for clarity) all work together to place dough 115 between the set of rollers 120, as described below.

The first roller is the feed roller 121 which is rotatability mounted on a central shaft 150 supported by first and second bearing assemblies 151, 152. Preferably first bearing assembly 151 is mounted at one end of the central shaft 150, between two vertically extending supports 155, 156. Likewise, second bearing assembly 152 is mounted at the opposite end of central shaft 150 and mounted between two vertically extending supports 157, 158. Bearing assemblies 151, 152 are preferably vertically adjustable and may be mounted at a desired height. The vertically extending supports 155, 156 are preferably connected to a horizontal stand 160. The horizontal stand 160 is preferably mounted to a secure surface, such as a factory floor (not separately labelled) with fasteners 161. The horizontal stand 160, vertically extending supports 155, 156 and bearing assembly 151 all constitute a first support assembly 165. Three additional support assemblies 166, 167, 168, preferably constructed in a corresponding manner to first support assembly 165, are provided at the ends of the feed roller 121, and mold roller 122 such that the set of rollers 120 is supported for rotation above the conveyor 140. The set of rollers 120 can either be positively driven by the bearing assemblies 151, 152 or simply be driven by the frictional engagement between the set of rollers 120 and the conveyor 140.

Mold roller 122 is formed with a plurality of spaced cavities 170 that function as dies. The cavities 170 are arranged in a series of circumferential rows 171, which are longitudinally spaced. The cavities 170 are also aligned longitudinally with mold roller 122. The cavities 170 may be round to produce dough pieces 105 that are round, or the cavities 170 may be of any desired shape so as to produce dough products of other shapes. Preferably, the cavities 170 are made of a stainless-steel alloy to reduce wear or a nonstick material to allow for easy release of the dough 115 from cavities 170. Other materials, such as food safe plastic, can also be employed especially when the cavities 170 are formed with a 3D printer. Additional details of a molding machine are described in U.S. Pat. No. 3,205,837 and European Patent No. 1008299, both of which are incorporated herein by reference.

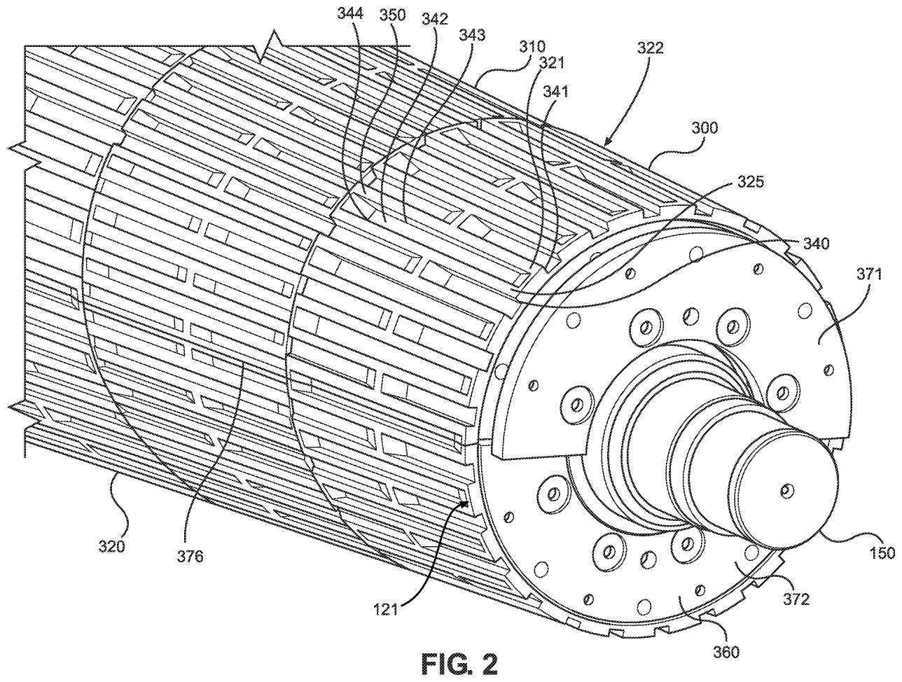

The feed roller 121, shown in more detail in FIG. 2, includes three axially spaced replaceable shells 300, 310, 320. The shells 300, 310, 320 are shown with ridges 321 on the outer surface 322 of the feed roller 121. The ridges 321 may have varying and/or repeating patterns. With specific reference to the replaceable shell 300, an exemplary ridge 325 extends radially out from the outer surface 322 of the feed roller 121 and extends longitudinally along the feed roller 121. Preferably, exemplary ridge 325 is provided with smooth sidewalls 340, 341. The ridges 321 may also have recesses 342 with side walls 343, 344 and end walls 345. The side walls 343, 344 rise to a top surface 350 forming a plateau. The ridges 321 may be of the same shape or different shapes, and several of the ridges 321 may form a repeating pattern around the replaceable shell 300. The overall pattern or panel design of the replaceable shell 300 also may be the same as present on other replaceable shells 310, 320, or the patterns may differ depending on the material to be fed by the feed roller 121.

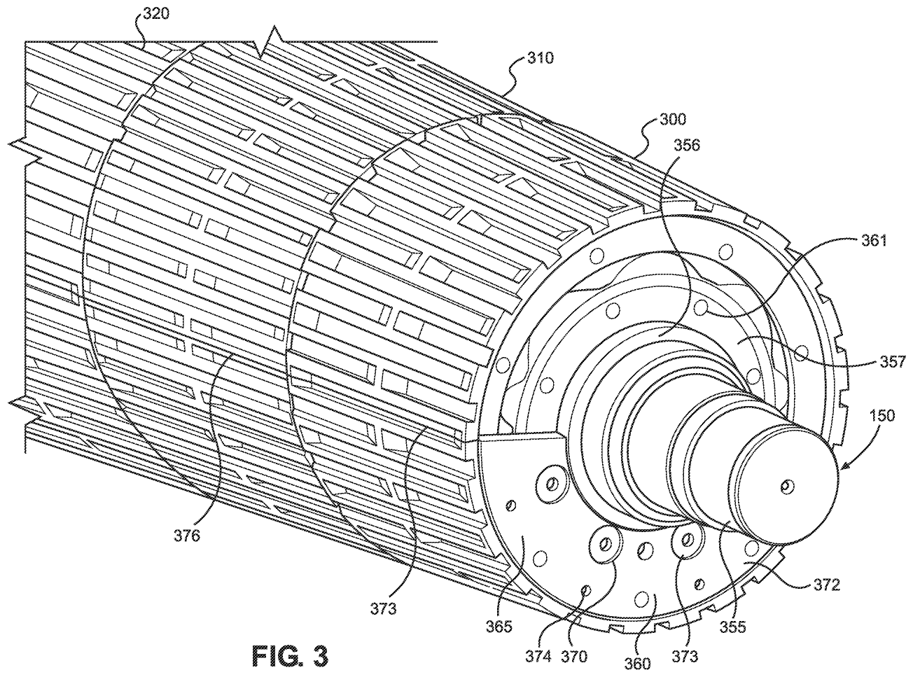

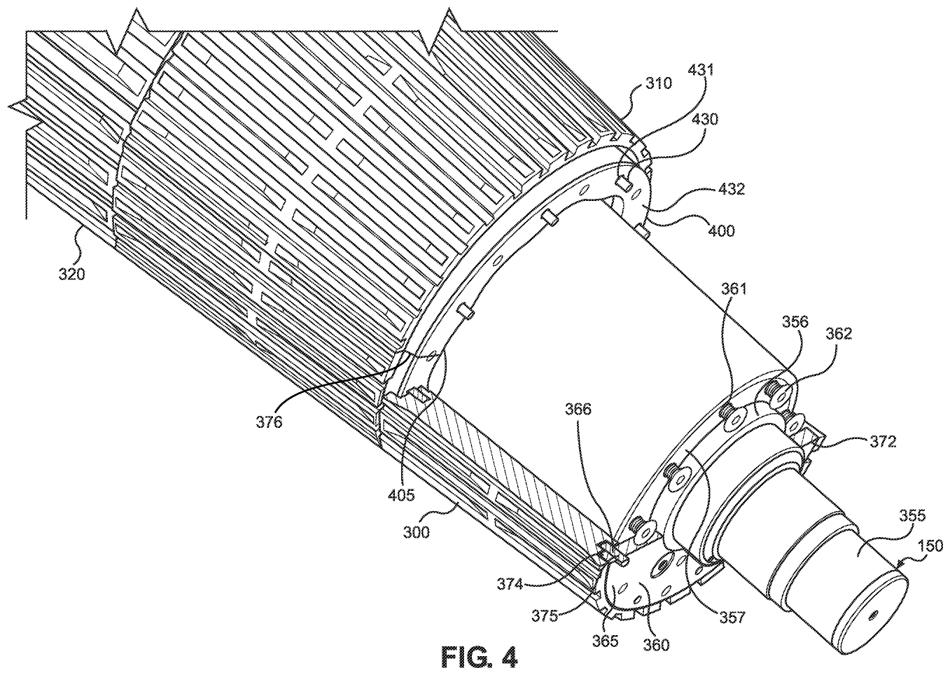

Turning to FIGS. 3 and 4, the central shaft 150 is shown with a support 355 configured to extend into bearing assembly 152. The central shaft 150 then extends axially from support 355 to a raised circumferentially extending ridge 356 that supports an end flange 360, also known as a thrust plate. The radius of the central shaft 150 increases just past end flange 360, thereby forming an axially facing annular wall 357. The axially facing annular wall 357 is formed with threaded mounting holes 361 which are preferably configured to receive threaded fasteners 362. As shown, the threaded mounting holes 361 are preferably arranged in an evenly spaced circular configuration.

The end flange 360 is generally formed in the shape of an annular washer and preferably made of metal. End flange 360 is thus formed with an end surface 365 and an abutment surface 366. The end flange 360 is provided with an inner set of threaded mounting holes 370 arranged in an evenly spaced circular configuration that aligns with the threaded mounting holes 361 in the axially facing annular wall 357. The end flange 360 is shown as having at least two subcomponents in the shape of half sections 371, 372, best seen in FIG. 1, that are placed together to form the washer shape which extends radially outward from central shaft 150. This arrangement allows for end flange 360 to be placed around central shaft 150 instead of being slid along central shaft 150.

Turning back to FIGS. 3 and 4, the inner set of threaded mounting holes 370 are preferably countersunk 373 to allow for the threaded fasteners 362 to be mounted flush with the end surface 365. FIG. 4 also shows the threaded fasteners 362 inserted into the threaded mounting holes 361 of the central shaft 150 with the half section 371 removed. An outer set of mounting holes 374 located radially outward of the inner set of threaded mounting holes 370 is also provided in abutment surface 366 to hold a set of pins 375, one of which is shown in cross-section in FIG. 4. Alternatively, pins 375 may simply be mounted on abutment surface 366 or press-fit into mounting holes 374. In each case, pins 375 extend axially from abutment surface 366.

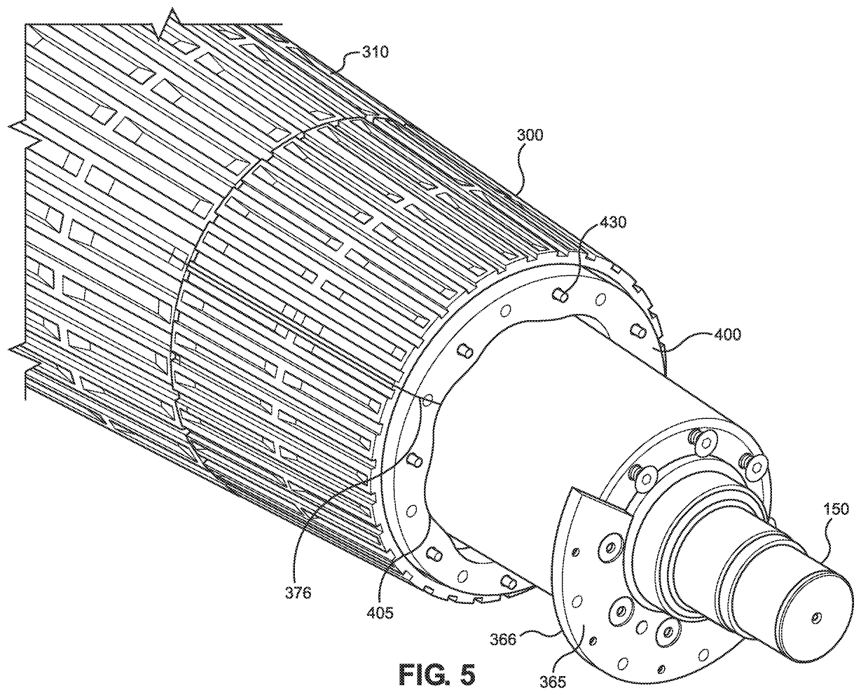

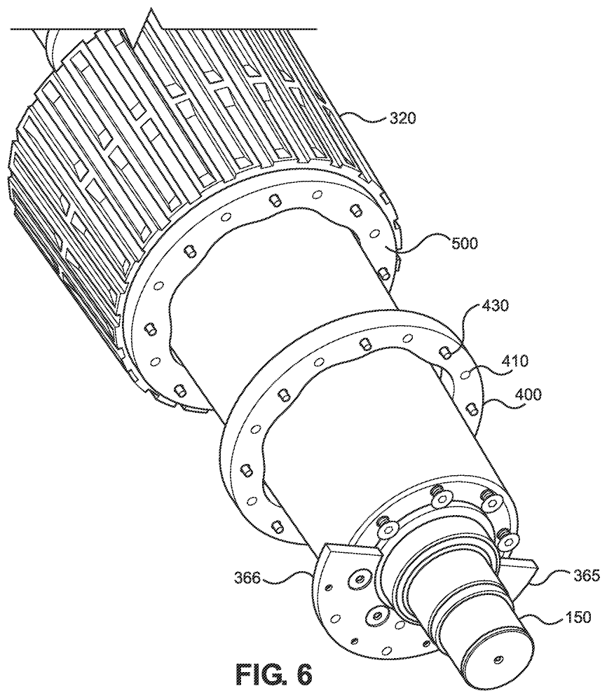

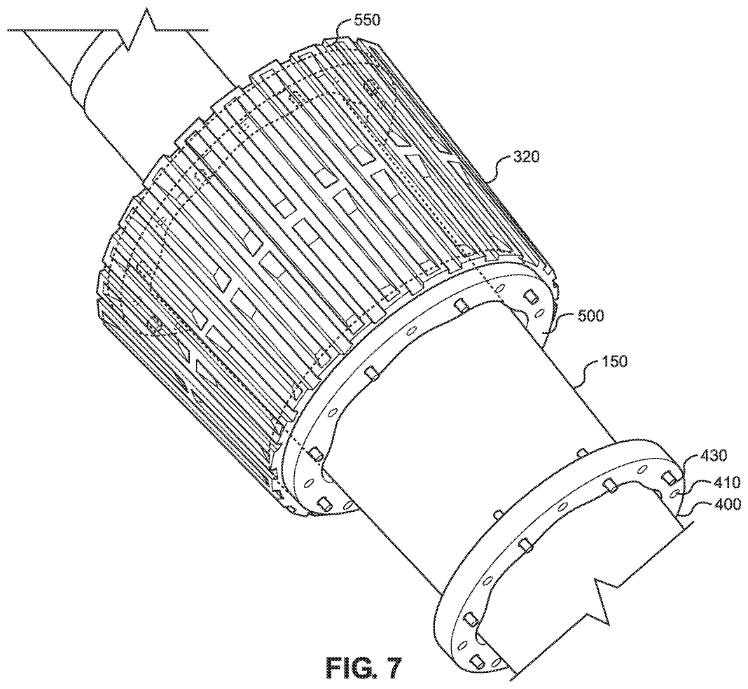

Turning now to FIGS. 4-8, there is shown a central flange 400, also known as a central plate, preferably formed in the shape of a washer which extends radially outward from central shaft 150. The central flange 400 has a larger central opening 405 when compared to the end flange 360 and, therefore, will easily slide along the central portion of the central shaft 150. The central flange 400 includes a set of mounting pins 430 aligned with the mounting holes 530 in the replaceable shell 300. The mounting pins 430 are either press-fit into the mounting holes 431 or attached to the surface 432 of the central flange 400. The mounting pins 430 extend from both sides of central flange 400 (see FIG. 7). The central flange 400 abuts the replaceable shell 300 and then the additional replaceable shell 310 is abutted with the central flange 400. Additional central flanges and replaceable shells are added as necessary. Alternatively, the central flange is split at line 376 (labeled in FIGS. 4, 5 and 8) into two pieces as to be mountable around the central shaft 150 without having to remove central shaft 150 from its operational position shown in FIG. 5. At this point, it should be noted that FIG. 5 shows replaceable shell 300 removed for clarity, while FIGS. 6 and 7 show replaceable shell 300 and replaceable shell 310 removed for clarity.

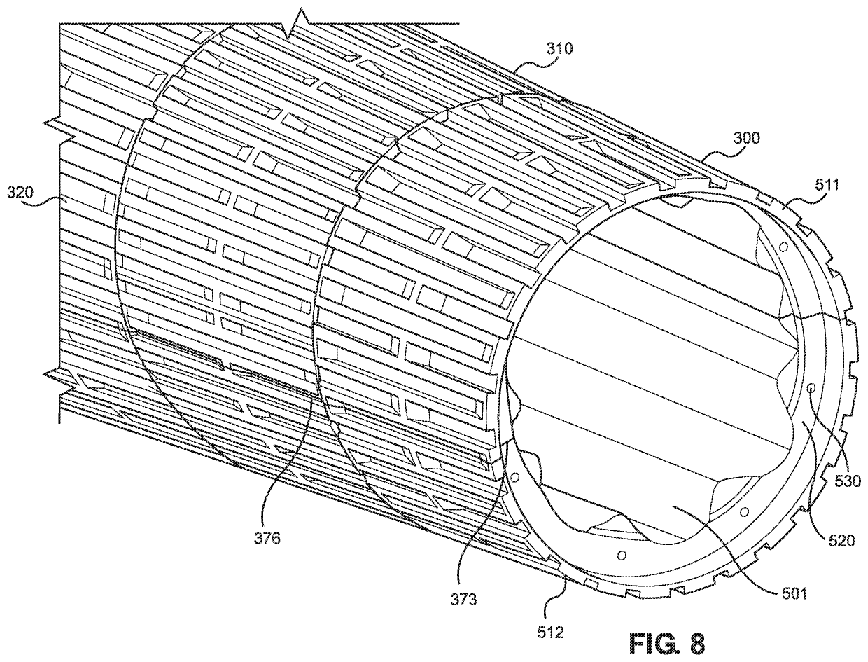

As best seen in FIG. 8, replaceable shell 300 is preferably formed in a cylindrical shape with a central, longitudinally extending opening 501 configured to slide on the central shaft 150. The replaceable shell 300 also may have a split shell design (note the line illustrating where replaceable shell 300 is split into two panels 511 and 512). The replaceable shell 300 has an outer surface covered with ridges as described above. End surfaces 520 of replaceable shell 300 are provided with axially extending holes 530 arranged to receive pins from with an end flange or a center flange.

The replaceable shells 300, 310, 320 of the feed roller 121 are preferably exchanged in order to remove a damaged or worn shell or to add a shell with a different type of outer surface designed to perform a different function. The replaceable shell 300 is formed of two panels mounted on the central shaft 150. To start, end flange 360 is placed on the central shaft 150. The central shaft 150 has an axially facing annular wall 357 with threaded mounting holes 370. The end flange 360 has a central aperture which allows the end flange 360 to be slid along the central shaft 150 until the end flange 360 abuts the axially facing annular wall 357. Threaded fasteners 362 are placed through the inner mounting holes 370 and into the threaded holes 361 to secure the end flange 360 in place. The replaceable shell 300 is slid along the central shaft 150 until the replaceable shell 300 abuts the end flange 360. The replaceable shell 300 is fastened to the end flange 360 by passing fasteners through mounting holes 530 on the replaceable shell 300 and into the outer mounting holes 374. An additional end flange 550, shown in FIG. 7, may then be placed on central shaft 150 and fastened thereto in a similar manner as end flange 360 by passing fasteners through outer mounting holes (the fasteners and mounting holes for replaceable shell 320 not separately labelled) of the additional end flange 550 and into mounting holes in the replaceable shell 320 and passing fasteners through the inner mounting holes of the additional end flange 550 into mounting holes in the central shaft 150. If a longer roller is employed, more replaceable shells 300, 310, 320 may be added by sliding a center flange 500 along the central shaft 150 to abut with the replaceable shell 320 and fastening the center flange 500 to the replaceable shell 320 by passing fasteners through mounting holes of the center flange 500 and into mounting holes in the replaceable shell 320 and then sliding the additional end flange 550 along the central shaft 150 to abut with the replaceable shell 320.

Based on the above, it should be readily apparent that the present invention provides a mechanism for replacing shells on a roller in order to ready change the outer surface of the roller. For example, with reference to FIG. 1, the mold roller 122 is provided with the same type of internal center flanges and end flanges as feed roller 121. This arrangement allows for replacing shells of feed roller 121 with the shells of the mold roller. Indeed, many different replaceable shells may be employed with the same mounting system. The shells have no external pins or connectors which could contaminate food. Also, seals could be added between shells to prevent contamination. The rollers could also be employed for cutters acting on a dough sheet, cracker production or any field of endeavor that would benefit from exchangeable surfaces on rollers.

While certain preferred embodiments of the present invention have been set forth, it should be understood that various changes or modifications could be made without departing from the spirit of the present invention. In general, the invention is only intended to be limited by the scope of the following claims.

1. A roller comprising:
a shaft extending in a longitudinal direction and having a central section including an axially facing wall formed with mounting holes;
a center flange extending radially outward from the shaft;
an end flange extending radially outward from the shaft and including inner mounting holes and outer mounting holes located radially outward of the inner mounting holes, wherein a fastener extends through one of the inner mounting holes in the end flange aligned with one of the mounting holes in the axially facing wall to fasten the end flange to the shaft; and
a replaceable shell removably mounted on the shaft between the center flange and the end flange.

2. The roller of claim 1, further comprising an outer fastener extending through one of the outer mounting holes in the end flange into a mounting hole in the replaceable shell, to fasten the replaceable shell to the end flange.

3. The roller of claim 2, wherein the fastener is a threaded fastener extending through one of the inner mounting holes in the end flange, and one of the mounting holes in the axially facing wall to fasten the end flange to the shaft.

4. The roller of claim 3, wherein the outer fastener is a pin extending through one of the outer mounting holes in the end flange into a mounting hole in the replaceable shell, to fasten the replaceable shell to the end flange.

5. The roller of claim 4, further comprising a pin extending through one of the mounting holes of the center flange into a mounting hole in the replaceable shell to fasten the replaceable shell to the center flange.

6. The roller of claim 1, wherein the end flange constitutes a first end flange, and the replaceable shell constitutes a first replaceable shell, and the roller further comprises a second end flange and a second replaceable shell mounted on the shaft.

7. The roller of claim 1, wherein the end flange includes at least two subcomponents that are configured to allow the end flange to be removed from the shaft without sliding the end flange along the shaft.

8. The roller of claim 1, wherein the replaceable shell includes at least two subcomponents that are configured to allow the replaceable shell to be removed from the shaft without sliding the replaceable shell along the shaft.

9. A food production line for producing dough products including the roller of claim 1, which constitutes a first roller, and further comprising a second roller mounted next to the first roller, wherein the first roller and the second roller are configured to pass dough therebetween.

10. A roller comprising:
a shaft extending in a longitudinal direction, the shaft having a central section including an axially facing wall formed with mounting holes;
a center flange extending radially outward from the shaft;
an end flange extending radially outward from the shaft, the end flange having inner mounting holes and outer pins located radially outward of the inner mounting holes; and
a replaceable shell removably mounted on the shaft between the center flange and the end flange.

11. The roller of claim 10, further comprising a threaded fastener extending through one of the inner mounting holes in the end flange and an aligned one of the mounting holes in the axially facing wall to fasten the end flange to the shaft.

12. The roller of claim 11, wherein the outer pins in the end flange fasten the replaceable shell to the end flange.

13. The roller of claim 10, further comprising a pin extending from the center flange into one of the mounting holes in the replaceable shell to fasten the replaceable shell to the center flange.

14. The roller of claim 10, wherein the end flange constitutes a first end flange, and the replaceable shell constitutes a first replaceable shell, and the roller further comprises a second end flange and a second replaceable shell.

15. The roller of claim 10, wherein the end flange includes at least two subcomponents that are arranged, in use, in a shape of a washer.

16. A method of mounting a replaceable shell of a roller comprising:
mounting an end flange, formed with inner mounting holes and outer mounting holes located radially outward of the inner mounting holes, on a shaft extending in a longitudinal direction and having a center flange extending radially outward from the shaft and a central section including an axially facing wall formed with mounting holes;
fastening the end flange to the shaft by placing fasteners through the inner mounting holes in the end flange which are aligned with the mounting holes in the axially facing wall of the shaft;
fastening the replaceable shell to the end flange by passing fasteners mounted on the end flange into mounting holes in the replaceable shell; and
fastening a center flange to the replaceable shell by passing fasteners mounted on the center flange into mounting holes in the replaceable shell so that the replaceable shell is removably mounted on the shaft between the center flange and the end flange.

17. The method according to claim 16, further comprising connecting two components of a replaceable shell around the shaft.

18. The method according to claim 17, further comprising sliding a second replaceable shell along the shaft until the second replaceable shell abuts the center flange, and wherein the end flange constitutes a first end flange, further comprising sliding a second end flange along the shaft to abut with the second replaceable shell.

19. The method according to claim 18, further comprising: fastening the second end flange to the second replaceable shell by passing fasteners through outer mounting holes of the end flange and into mounting holes in the replaceable shell and passing fasteners through the inner mounting holes of the end flange into mounting holes in the shaft.

20. The method according to claim 18, wherein the roller constitutes a first roller, further comprising: placing the first roller next to a second roller and passing dough therebetween, wherein the first and second rollers are part of a production line for processing dough.
